(19) United States
(12) Patent Application Publication
(10) Pub. No.: US 2003/0107197 A1
(43) Pub. Date: Jun. 12, 2003

(54) Wheelchair with an anti-wobbling roller

(76) Inventor: Ya-Chen Chao, Taichung Hsien (TW)

Correspondence Address: John F. Gulbin, Pitney, Hardin, Kipp & Szuch LLP, 711 Third Avenue, 20th Floor, New York, NY, 10017, US

(21) Appl. No.: 10/013,387

(22) Filed: Dec. 11, 2001

(51) Int. Cl. B62M 1/14; B60P 1/00

(52) U.S. Cl. 280/80.1; 280/250.1; 280/124.1; 180/65.1

(57) ABSTRACT

A wheelchair includes an anti-wobbling roller mounted at a front portion of a seat frame and spanning across a center of the front portion in such a manner that the roller is capable of balancing the wheelchair in case the roller collides with an obstacle during forward movement of the wheelchair.

### BACKGROUND OF THE INVENTION

1. Field of the Invention

The present invention relates to a wheelchair, more particularly to a wheelchair which includes an anti-wobbling roller for balancing the wheelchair in case the roller collides with an obstacle during forward movement of the wheelchair.

2. Description of the Related Art

Referring to FIG. 1, a conventional wheelchair 20 is shown to include a seat frame 10, a pair of drive wheels 13 (only one is shown), a pair of ground-engaging castor-type idler wheels 15 (only one is shown), a pair of forward idler wheels 32 (only one is shown), and a resilient suspension unit 33.

As illustrated, the seat frame 10 has opposing front and rear frame portions 12, 16, left and right frame portions 14 (only one is visible) interconnecting the front and rear frame portions 12, 16, and a bottom side. The drive wheels 13 are mounted on the left and right frame portions 14 between the front and rear frame portions 12, 16, and are rotatable about a first axis. The idler wheels 15 are mounted on the rear frame portion 16 of the seat frame 10, and are rotatable about a second axis parallel to the first axis, and further about a vertical axis which is transverse to the first and second axes during left and right turning movement of the wheelchair 20. The forward idler wheels 32 are mounted on the front frame portion 12 via a transverse rod 30 that extends in a direction parallel to the first axis. The resilient suspension unit 33 includes left and right suspension springs disposed between left and right sides of the front frame portion 12 and the idler wheels 32 for absorbing shocks.

One drawback of the aforementioned conventional wheelchair 20 resides in that during forward movement of the wheelchair 20 and in case only one of the forward idler wheels 32 collides with an obstacle which is higher than the ground surface, the vibration resulting from said collision will be transmitted to the seat frame 10 to the largest extent, since the vibration is not shared by the other suspension spring which is away from the colliding idler wheel 32.

### SUMMARY OF THE INVENTION

Therefore, the object of this invention is to provide a wheelchair which includes an anti-wobbling roller mounted on a front frame portion of the wheelchair in order to avoid the occurrence of the aforesaid drawback that generally results during use of the conventional wheelchair.

Accordingly, a wheelchair of the present invention includes a seat frame, a pair of drive wheels, a pair of ground-engaging castor-type idler wheels, an elongated anti-wobbling roller, and shock-absorbing means. The seat frame has opposing front and rear frame portions, left and right frame portion interconnecting the front and rear frame portions, and a bottom side. The front frame portion has left and right ends. The front and rear frame portions cooperatively define a center line that passes through centers of the front and rear frame portions. The drive wheels are mounted on the left and right frame portions between the front and rear frame portions, and are rotatable about a first axis. Each of the drive wheels has a lowermost end for contacting a ground surface. The ground-engaging castor-type idler wheels are mounted on the rear frame portion, and are rotatable about a second axis parallel to said first axis and further about a vertical axis which is transverse to the first and second axes. The anti-wobbling roller is disposed below the bottom side of the seat frame adjacent to the front frame portion, extends between the left and right frame portions, crosses the center line, and has a lowermost end disposed at an elevation which is higher than the lowermost ends of the drive wheels. The shock-absorbing means is interposed between and connects the anti-wobbling roller and the seat frame for absorbing shock that results when the roller collides with an obstacle during forward movement of the wheelchair.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a schematic side view of a conventional wheelchair;

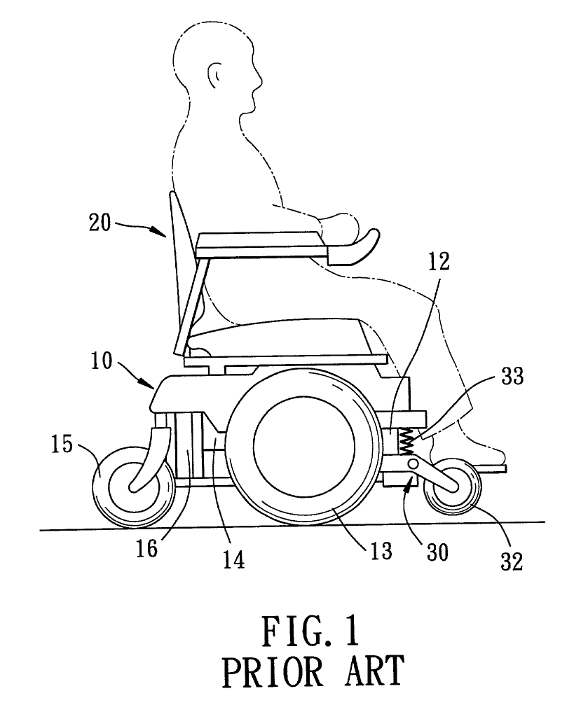

FIG. 2 is a partly exploded, perspective view of a preferred embodiment of a wheelchair of the present invention, in which a seat is removed from a seat frame for the sake of clarity;

FIG. 3 is an assembled perspective view of the preferred embodiment of the present invention;

FIG. 4 is a side view of the preferred embodiment, illustrating how an anti-wobbling roller is mounted thereto; and

FIG. 5 is a front view of the preferred embodiment shown in FIG. 2.

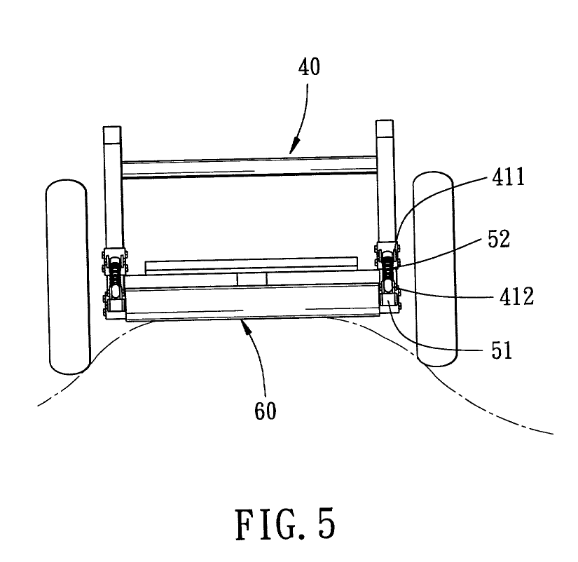

### DETAILED DESCRIPTION OF THE PREFERRED EMBODIMENT

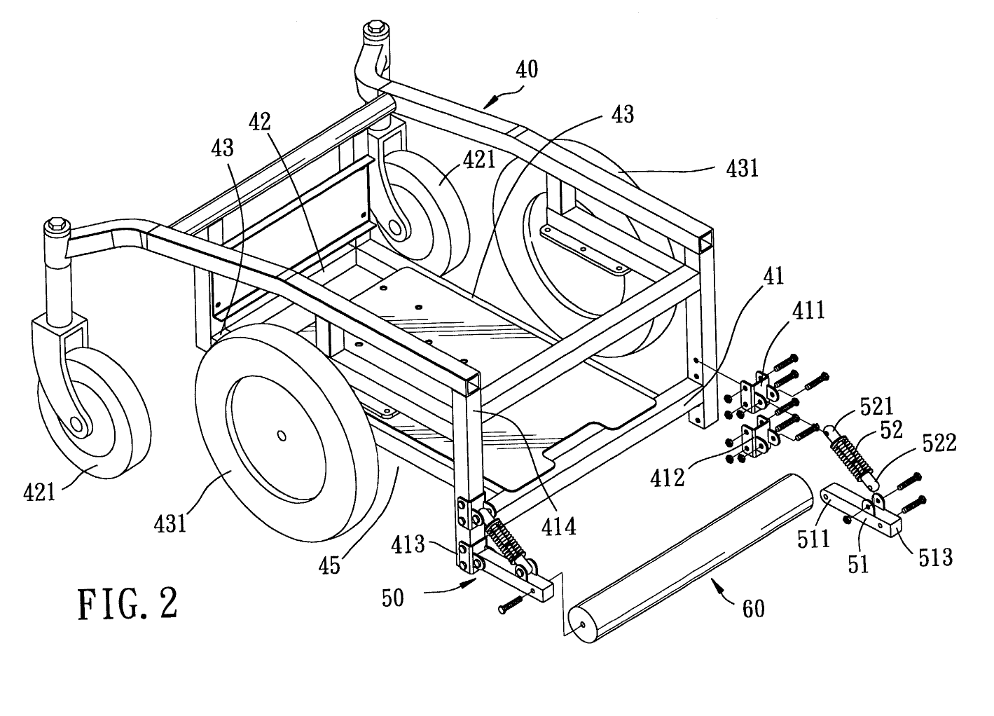

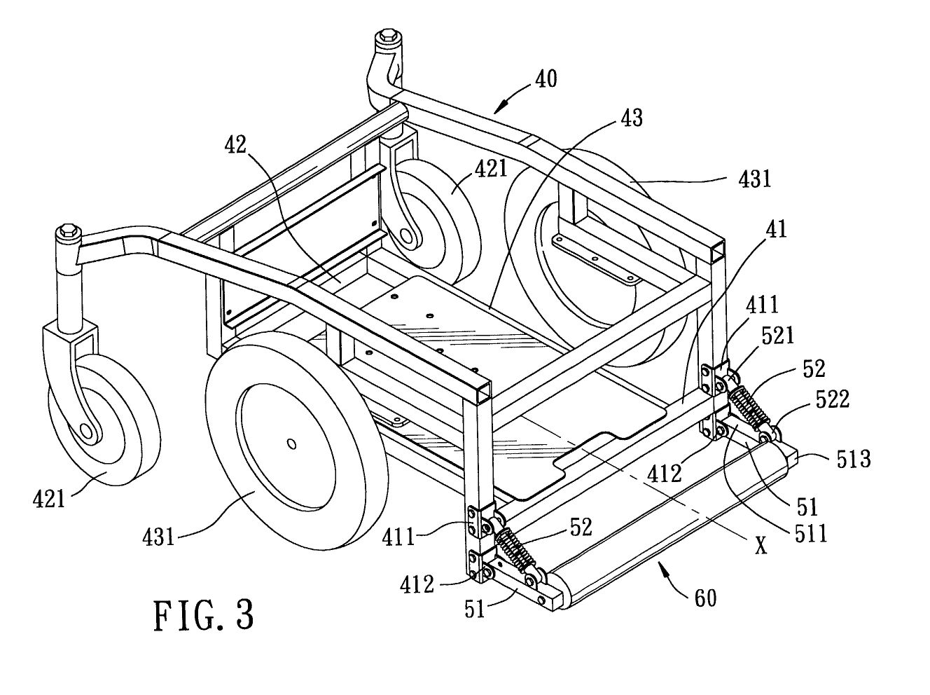

Referring to FIGS. 2, 3 and 4, the preferred embodiment of a wheelchair of the present invention is shown to include a seat frame 40, a pair of drive wheels 431, a pair of ground-engaging castor-type idler wheels 421, an elongated anti-wobbling roller 60, and shock-absorbing means 52.

As illustrated, the seat frame 40 has opposing front and rear frame portions 41, 42, left and right frame portion 43 which interconnect the front and rear frame portions 41, 42, and a bottom side 45. The front frame portion 41 has left and right ends. The front and rear frame portions 41, 42 cooperatively define a center line (X) that passes through centers of the front and rear frame portions 41, 42.

The drive wheels 431 are mounted on the left and right frame portions 43 between the front and rear frame portions 41, 42, and are rotatable about a first axis. Each of the drive wheels 431 has a lowermost end for contacting a ground surface.

The idler wheels 421 are mounted on the rear frame portion 42, and are rotatable about a second axis parallel to the first axis, and further about a vertical axis which is transverse to the first and second axes.

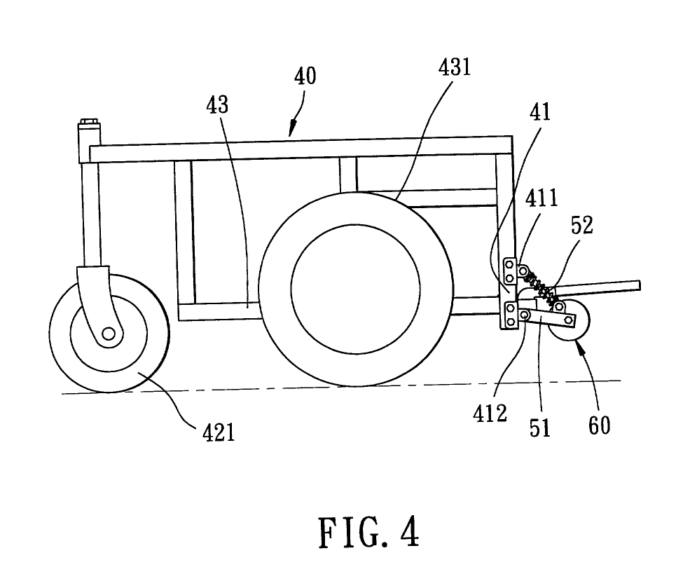

The anti-wobbling roller 60 is disposed below the bottom side 45 of the seat frame 40 adjacent to the front frame portion 41, extends between the left and right frame portions 43, and crosses the center line (X) defined by the front and rear frame portions 41, 42. The roller 60 has a lowermost end disposed at an elevation which is higher than the lowermost ends of the drive wheels 431 (see FIG. 4).

The shock-absorbing means 52 is interposed between and connects the anti-wobbling roller 60 and the seat frame 40 for absorbing shock that results when the roller 60 collides with an obstacle during forward movement of the wheelchair.

The seat frame 40 further has a pair of left and right legs 413 extending downwardly from the left and right ends of the front frame portion 41, and a pair of connecting rods 51 that extend frontwardly from the left and right legs 413 in a direction parallel to the center line (X) and that have rear ends 511 pivoted respectively to the left and right legs 413 via brackets 412, and front ends 513 between which the roller 60 is journalled. The seat frame 40 further has a pair of upright posts 414 that extend from the left and right ends of the front frame portion 41 in directions opposite to the left and right legs 413, respectively. The shock-absorbing means 52 includes a pair of shock-absorbing cylinders respectively having two opposite ends 521, 522, each of which is pivoted to a respective one of the connecting rods 51 and a respective one of the upright posts 414 via a bracket 411.

Since vibrations that result from collision between the roller 60 and the obstacle during forward movement of the wheelchair of the present invention can be uniformly absorbed by the cylinders, a large extent of the vibrations is not transmitted to the seat frame 40. In addition, a large surface area of the roller 60 contacts the obstacle so as to enhance balancing of the seat frame 40. Since the features of the present invention do not reside in the specific structure of a seat and mounting of the same on the seat frame 40, a detailed description thereof is omitted herein for the sake of brevity.

With this invention thus explained, it is apparent that numerous modifications and variations can be made without departing from the scope and spirit of this invention. It is therefore intended that the invention be limited only as indicated in the appended claims.

I claim:

1. A wheelchair comprising:
a seat frame having opposing front and rear frame portions, left and right frame portions interconnecting said front and rear frame portions, and a bottom side, said front frame portion having left and right ends, said front and rear frame portions defining a center line that passes through centers of said front and rear frame portions;
a pair of drive wheels mounted on said left and right frame portions between said front and rear frame portions and rotatable about a first axis, each of said drive wheels having a lowermost end for contacting a ground surface;
a pair of ground-engaging castor-type idler wheels mounted on said rear frame portion and rotatable about a second axis parallel to said first axis, and further about a vertical axis which is transverse to said first and second axes;
an elongated anti-wobbling roller disposed below said bottom side of said seat frame adjacent to said front frame portion, extending between said left and right frame portions, crossing said center line, and having a lowermost end disposed at an elevation which is higher than said lowermost ends of said drive wheels; and
shock-absorbing means interposed between and connecting said anti-wobbling roller and said seat frame for absorbing shock that results when said roller collides with an obstacle during forward movement of the wheelchair.

2. The wheelchair as defined in claim 1, wherein said seat frame further has a pair of left and right legs extending downwardly from said left and right ends of said front frame portion, and a pair of connecting rods that extend frontwardly from said left and right legs in a direction parallel to said center line and that have rear ends pivoted respectively to said left and right legs, and front ends between which said roller is journalled, said seat frame further having a pair of upright posts that extend from said left and right ends of said front frame portion in directions opposite to said left and right legs, respectively, said shock-absorbing means including a pair of shock-absorbing cylinders respectively having two opposite ends, each of which is pivoted to a respective one of said connecting rods and a respective one of said upright posts.
